(19) United States
(12) Patent Application Publication
(10) Pub. No.: US 2015/0160863 A1
(43) Pub. Date: Jun. 11, 2015

(54) UNIFIED MEMORY TYPE AWARE STORAGE MODULE

(71) Applicant: Memory Technologies LLC, Las Vegas, NV (US)

(72) Inventor: Kimmo Juhani Mylly, Ylojarvi (FI)

(21) Appl. No.: 14/566,547

(22) Filed: Dec. 10, 2014

Related U.S. Application Data
(60) Provisional application No. 61/914,325, filed on Dec. 10, 2013.

(51) Int. Cl. G06F 3/06

(52) U.S. Cl. CPC G06F 3/0604; G06F 3/0631; G06F 3/0679

(57) ABSTRACT

A storage device includes memory blocks having a plurality of memory circuits for storing data. The storage device includes an interface to connect the storage module to a host having system memory The storage device includes at least one register for providing information about a type of system memory to be allocated to the storage device. The storage device is configured to utilize the system memory based at least in part upon the information about the type of system memory.

### RELATED APPLICATIONS

The present application claims priority to U.S. Provisional Application No. 61/914,325, filed Dec. 10, 2013, and entitled “Unified Memory Type Aware Storage Module,” the entirety of which is incorporated herein. This application is related to U.S. application Ser. No. 12/455,763, filed Jun. 4, 2009, now patented as U.S. Pat. No. 8,874,824, U.S. application Ser. No. 13/451,951, filed Apr. 20, 2012, U.S. application Ser. No. 13/596,480, filed Aug. 28, 2012, and U.S. application Ser. No. 11/176,669, filed Jul. 8, 2005, now patented as U.S. Pat. No. 7,827,370, each of which are assigned to the assignee of the present application. Each of these related applications are incorporated herein by reference in their entireties.

### BACKGROUND

Managed storage modules, such as managed NAND storage modules, provide many benefits over using raw memories such as flash NAND memories. Managed storage modules, which typically include a storage controller combined with NAND memory in the case of managed NAND or other types of memory in other cases, provide several benefits to device manufacturers. The storage controller hides the details of the memory (e.g., NAND) and provides the intended interface and other features, such as ECC support without the device manufacturers having to implement those features on the host side (e.g., on a smartphone or tablet). Additionally, managed storage modules allow new advanced features to be implemented in the storage controller without the host necessarily having to be aware that the features exist. The advanced features can either be activated or not used by the storage controller depending on whether the host supports the features. Thus, managed storage modules improve backwards compatibility.

Examples of managed storage modules, and in particular managed NAND storage modules, include embedded multimedia cards (eMMC), Universal Flash Storage (UFS), solid-state drive (SSD) modules. These modules are used in a wide variety of applications like mobile phones, Global positioning system (GPS) devices, media players, PCs, and servers for storing the operating system code, applications, and user data, such as, code, photos, and videos. Along with the data visible to the host device, operational code/firmware (FW) of the storage module itself is stored in the memory of the storage module. Additionally, other important data, which is needed to operate the memory module, such as register data and address translation data, may be stored in the memory.

These managed storage modules include some limited amount of execution memory (e.g., embedded SRAM in the storage controller) for run-time storage of firmware (FW) and other system/operation information. Some high-end applications like SSDs also include additional DRAM. The amount of embedded SRAM and discrete DRAM inside a storage module is a matter of balancing cost, performance, and power consumption.

There is a known alternative for the fixed memory configuration mentioned above, e.g. the Joint Electron Device Engineering Council (JEDEC) UFS Unified Memory (UM) extension. Per this definition, a storage module may be allocated a portion of system memory resources (typically system DRAM) via the host controller and Direct Memory Access (DMA) channel without interrupting the system processor.

Some of the above features are described in U.S. application Ser. No. 12/455,763, filed Jun. 4, 2009, now patented as U.S. Pat. No. 8,874,824, U.S. application Ser. No. 13/451,951, filed Apr. 20, 2012, and U.S. application Ser. No. 13/596,480, filed Aug. 28, 2012, each of which are assigned to the assignee of the present application.

### SUMMARY

Embodiments of the present disclosure include a storage module comprising memory blocks having a plurality of memory circuits for storing data. An interface is configured to connect the storage module to a host having system memory. A first register is configured to provide data that indicates whether a first type of system memory is supported by the storage module when the storage module uses a unified memory, wherein the unified memory includes some system memory. A second register is configured to provide data that indicates whether a second type of system memory is supported by the storage module when using the unified memory. A third register is configured to receive data that indicates the amount of system memory of the first type included in the unified memory. And a controller is configured to use the unified memory in accordance with the amount indicated in the third register.

Embodiments of the present disclosure include a storage device comprising memory blocks having a plurality of memory circuits for storing data. An interface to connect the storage device to a host having system memory is included in the storage device. The storage device includes at least one register for providing information about a type of system memory to be allocated to the storage device, and the storage device is configured to utilize the system memory based at least in part upon the information about the type of system memory.

In some embodiments, the at least one register corresponds to the type of system memory to be allocated to the storage device, and the information provided by the at least one register relates to an amount of the type of system memory to be allocated to the storage device. In some embodiments, the storage device is further configured to utilize the system memory by writing to the system memory. In some embodiments, the information about the type of system memory comprises bits identifying the type of system memory. In some embodiments, the type of system memory is at least one of volatile memory or non-volatile memory. In some embodiments, the type of system memory relates to a degree of heat tolerance. In some embodiments, the type of system memory relates to a level of power consumption. In some embodiments, the storage device is further configured to store the data in the type of system memory based on an importance of the data.

In some embodiments, the storage device further comprises another register for providing other information about another type of system memory to be allocated to the storage device, wherein the storage device is further configured to utilize the system memory at least based on the information about the type of system memory and the other information about the other type of system memory.

In some embodiments, the storage device further comprises random access memory (RAM) configured to store operating information. In some embodiments, the type of system memory to be allocated to the storage device, along with the RAM, is at least part of a unified memory. In some embodiments, the type of system memory to be allocated to the storage device is at least part of a unified memory. In some embodiments, the RAM is at least one of magnetoresistive RAM (MRAM), ferroelectric RAM (FE-RAM), or resistive RAM.

In some embodiments, the storage device further comprises a random access memory (RAM) that is configured to store operating information, wherein the RAM is included in a unified memory. The type of system memory to be allocated to the storage device, along with the RAM, is at least part of the unified memory and the type of system memory is a first type of system memory. The storage device further comprises another register configured to receive other information that indicates an amount of system memory of a second type of system memory included in the unified memory. The unified memory includes a first portion of the system memory of the first type and a second portion of the system memory of the second type. The storage device is further configured to utilize a first portion of the unified memory for a different purpose than that a second portion of the unified memory, wherein the first portion of the unified memory includes the first portion of the system memory and the second portion of the unified memory includes the second portion of the system memory

In some embodiments, the at least one register of the storage device is an attribute-register of Universal Flash Storage (UFS) standard.

Embodiments of the present disclosure include a storage device comprising a plurality of memory circuits for storing data. An interface to connect the storage device to a host having system memory is included in the storage device. The storage device includes at least one register for providing information about a type of system memory to be allocated to the storage device, The storage device includes a storage controller configured to utilize the system memory based at least in part upon the information about the type of system memory.

In some embodiments, the at least one register corresponds to the type of system memory to be allocated to the storage device, and the information provided by the at least one register relates to an amount of the type of system memory to be allocated to the storage device. In some embodiments, the storage controller is further configured to utilize the system memory by writing to the system memory. In some embodiments, the information about the type of system memory comprises bits identifying the type of system memory. In some embodiments, the type of system memory is at least one of volatile memory or non-volatile memory. In some embodiments, the type of system memory relates to a degree of heat tolerance. In some embodiments, the type of system memory relates to a level of power consumption. In some embodiments, the storage controller is further configured to store the data in the type of system memory based on an importance of the data.

In some embodiments, the storage device further comprises another register for providing other information about another type of system memory to be allocated to the storage device, wherein the storage controller is further configured to utilize the system memory based at least on the information about the type of system memory and the other information about the other type of system memory.

In some embodiments, the storage device further comprises random access memory (RAM) configured to store operating information. In some embodiments, the type of system memory to be allocated to the system memory along with the RAM is at least part of a unified memory. In some embodiments, the type of system memory to be allocated to the system memory is at least part of a unified memory. In some embodiments, the RAM is at least one of magnetoresistive RAM (MRAM), ferroelectric RAM (FE-RAM), or resistive RAM.

In some embodiments, the storage device further comprises a random access memory (RAM) that is configured to store operating information, wherein the RAM is included in a unified memory. The type of system memory to be allocated to the storage device, along with the RAM, is at least part of the unified memory and the type of system memory is a first type of system memory. The storage controller further comprises another register configured to receive other information that indicates an amount of system memory of a second type of system memory included in a unified memory. The unified memory includes a first portion of the system memory of the first type and a second portion of the system memory of the second type. The storage controller is further configured to utilize a first portion of the unified memory for a different purpose than that for the second portion of the unified memory, wherein the first portion of the unified memory includes the first portion of the system memory and the second portion of the unified memory includes the second portion of the system memory.

In some embodiments, the at least one register is an attribute-register of Universal Flash Storage (UFS) standard.

Embodiments of the present disclosure include a method comprising storing, by a storage device, data in a plurality of memory circuits, providing, by at least one register of the storage device to a host having system memory, information about a type of system memory to be allocated to the storage device, and utilizing, by the storage device, the system memory based at least in part upon the information about the type of system memory. In some embodiments the at least one register corresponds to the type of system memory to be allocated to the storage device, and the information provided by the at least one register relates to an amount of the type of system memory to be allocated to the storage device.

In some embodiments, the utilizing comprises writing some or all of the data to the system memory. In some embodiments, the type of system memory is at least one of volatile memory or non-volatile memory. In some embodiments, the type of system memory relates to a degree of heat tolerance. In some embodiments, the type of system memory relates to a level of power consumption.

In some embodiments, another register contains other information about another type of system memory that is allocated to the storage device, and the method further comprises utilizing the system memory based at least in part on the information about the type of system memory and the other information about the other type of system memory.

Embodiments of the present disclosure include a host system that includes system memory, an interface for interfacing the host system with a storage device that comprises a plurality of memory circuits for storing data, and a host controller. The host controller is configured to receive, from the storage device, a system memory allocation request including at least a type of system memory, allocate, based on the system memory allocation request, an amount of the type of system memory to the storage device, wherein the storage device includes at least one register for providing information about the type of system memory to be allocated to the storage device.

In some embodiments, the host controller is configured to receive the system memory allocation request by reading the system memory allocation request from the at least one register of the storage device. In some embodiments, the at least one register of the storage device is associated with the type of system memory requested in the system memory allocation request. In some embodiments, the at least one register of the storage device stores at least the type of system memory requested in the system memory allocation request.

In some embodiments, the host controller is configured to transmit the information indicating at least the type of system memory allocated to the storage device by writing the amount of the type of system memory allocated to the storage device to another register of the storage device. In some embodiments, the other register of the storage device is associated with the type of system memory allocated to the storage device. In some embodiments, the other register of the storage device stores at least the type of system memory allocated to the storage device.

Embodiments of the present disclosure include a storage device, comprising means for storing data, means for connecting the storage device to a host having system memory, means for providing information about a type of system memory to be allocated to the storage device, and means for utilizing the system memory based at least in part upon the information about the type of system memory. In some embodiments, the means for providing information about the type of system memory to be allocated to the storage device corresponds to the type of system memory to be allocated to the storage device, and the information provided by the means for providing information about a type of system memory to be allocated to the storage device relates to an amount of the type of system memory to be allocated to the storage device. In some embodiments, the storage device further comprises means for providing other information about another type of system memory that is allocated to the storage device, wherein the means for utilizing the system memory is further based on the other information about the other type of system memory.

### BRIEF DESCRIPTION OF THE DRAWINGS

FIG. 1 depicts an example host device.

FIG. 2 depicts an embodiment of a storage module.

FIG. 3 depicts a process flow of a first embodiment of the disclosure where the storage module communicates the requested amount(s) and type(s) of system memory for use by the storage module to the host.

### DETAILED DESCRIPTION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

When a conventional storage module or storage device (e.g., a managed storage module or managed storage device), requests and is allocated system memory from a host, the conventional storage module has no knowledge of the type of memory that has been allocated. Instead, it is assumed that the allocated memory is volatile memory (e.g., DRAM). However, it may be beneficial for a storage module to be aware of the type and/or features/characteristics of the allocated system memory so that the storage module may take advantage of any of the features/characteristics unique to the type of allocated system memory. This type of capability may become even more important as host systems start to integrate multiple types of system memory (e.g., resistive RAM, magnetic RAM, or other non-volatile RAMs). Accordingly, below, embodiments of the present disclosure are described that allow for the storage module to be aware of the type of allocated system memory and to change the storage module behavior based on the type of allocated system memory.

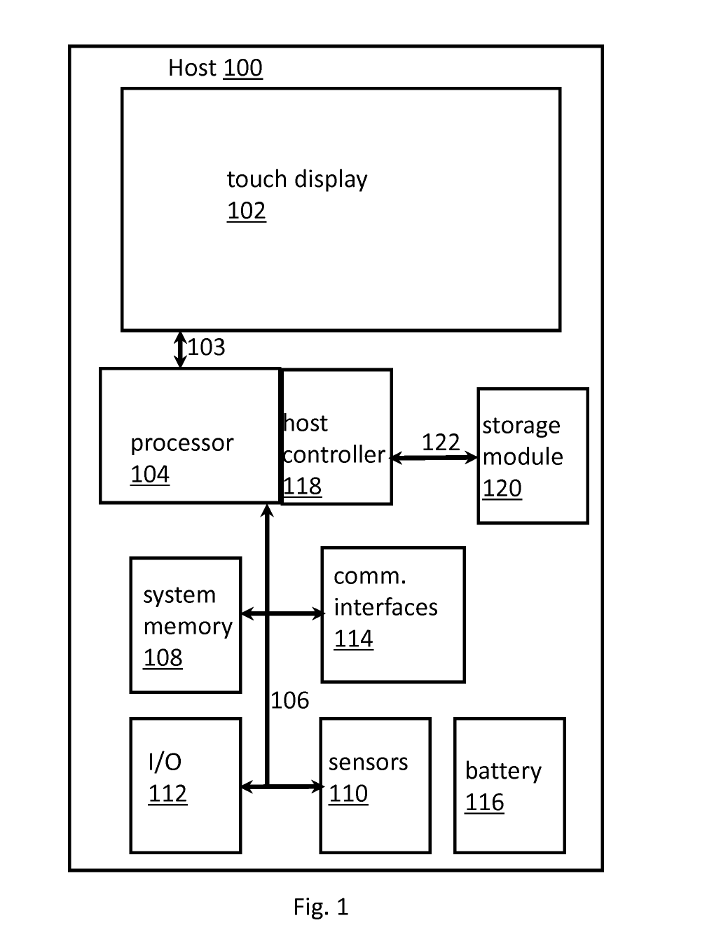

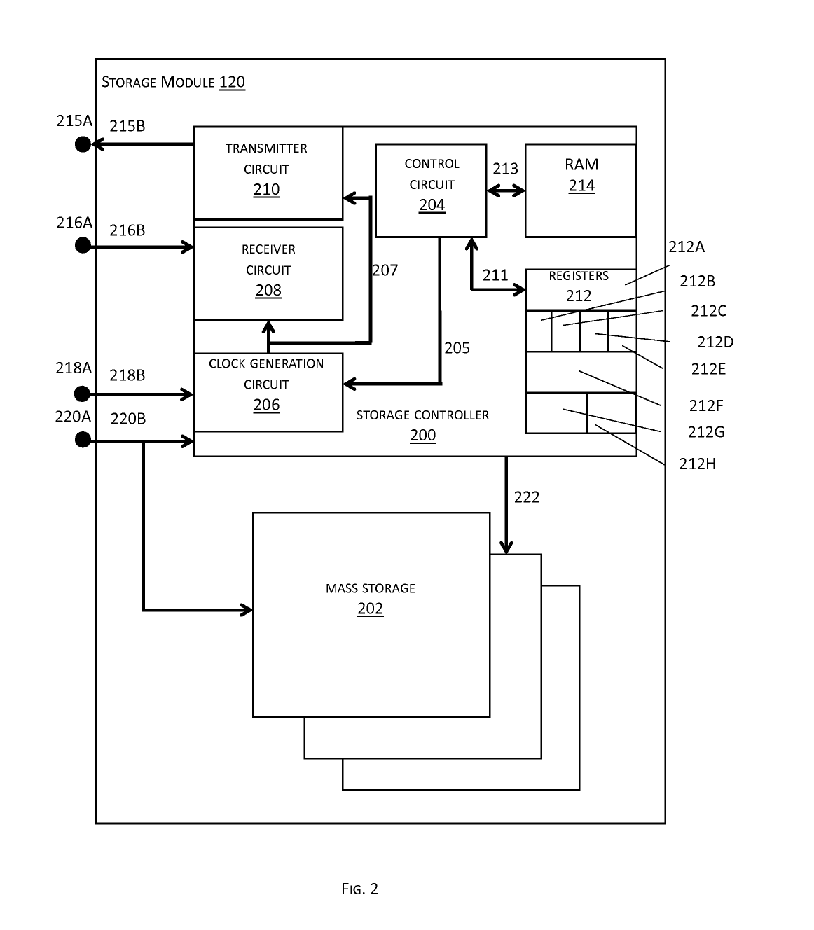

FIG. 1 depicts an example host 100, e.g., a host device such as a smartphone device or a tablet device, that may utilize embodiments of the present disclosure. Host 100 includes a touch display 102 that is sensitive to a user's touch based on capacitive or resistive detection. Bus 103 connects touch display 102 to processor 104, which may include a graphics subsystem that handles the display of graphics and text on touch display 102. Host 100 also includes a number of other components connected to processor 104 through shared bus 106, including system memory 108 (e.g., DRAM), sensors 110 (e.g., accelerometers, gyroscope, GPS), input/output (I/O) 112 (e.g., a speaker, a microphone, or a keyboard), and communications interfaces 114 (e.g., Universal Serial Bus (USB), WiFi, Bluetooth, or other wired or wireless interfaces). Processor 104 may also include host controller 118 (which may be alternatively connected to but separate from processor 104) that interfaces with storage module 120 over bus 122. Storage modules according to embodiments, including storage module 120, include one or more storage devices. Alternatively, host controller 118 may interface with storage module 120 over shared bus 106. Both shared bus 106 and bus 122 may include several bus lines for data, commands, clocking signals, power, reset, etc. An example of the bus lines included in bus 122 is described below with respect to FIG. 2. Battery 116 provides power to the above described components through a power supply bus and/or lines (not shown).

While the use of storage module 120 is shown in the context of a touch sensitive smartphone device or tablet device, embodiments of the present disclosure are not limited to use in such devices. Embodiments of the present disclosure may be applied to any electronic device that utilizes storage, e.g., wearable computers such as smartwatches or glasses, televisions, cameras, netbooks, gaming consoles, personal computers, servers, set top boxes, and the like. Additionally, the architecture of host 100 is provided for illustrative purposes only and should not be considered limiting.

FIG. 2 depicts an exemplary architecture for storage module 120 that may implement embodiments of the present disclosure. Storage module 120 may be a memory storage device contained within a package (e.g. a ball grid array (BGA) package) that is designed to be mounted on a printed circuit board. For example, storage module 120 may be an embedded multimedia card (eMMC) or Universal Flash Storage (UFS) module. Alternatively, storage module 120 may be a memory storage device contained within a removable card that fits within a slot on the host 100 or a semi-removable device such as an SSD module or PC/server cards/modules (e.g., PCIe cards). Additionally, although storage module 120 is shown as being one self-contained storage device, storage module 120 may also be implemented with a collection of interconnected devices.

As shown in FIG. 2, storage module 120 includes storage controller 200 for communicating data between mass storage 202 and host 100 (see FIG. 1). Storage controller 200 includes control circuit 204 for controlling the operation of storage controller 200. Control circuit 204 may be connected to RAM 214 over bus 213 for storing operating information and/or temporary storage as specified by storage module 120. Storage controller 200 also includes clock generation circuit 206 for generating an internal clocking signal on internal clock line 207, receiver circuit 208 for receiving data, status and commands from host controller 118 (see FIG. 1), transmitter circuit 210 for transmitting data, commands and status information to host controller 118 (see FIG. 1), and registers 212 for storing information and settings relating to the operation of storage module 120, including information related to the generation of the internal clocking. Control circuit 204 may use bus 211 to access or write information to registers 212. Storage module 120 communicates with host controller 118 through data out line 215B and data terminal 215A, which may provide data, commands and status information, and data in line 216B and data terminal 216A, which may provide data, commands, and status information.

Storage module 120 also includes reference clock line 218B and reference clock terminal 218A that provide a reference clock signal to clock generation circuit 206, and power line 220B and power terminal 220A that provide power to storage controller 200 and mass storage 202. While the above lines and terminals are shown to be single lines and terminals in FIG. 2, each line and terminal may be made up of multiple lines and terminals. For example, power terminal 220A may include multiple terminals associated with multiple lines of power line 220B that each individually provide power to the different components (e.g., mass storage 202 and storage controller 200). As another example, data out line 215B and data out terminal 215A or data in line 216B and data in terminal 216A may be implemented using two lines (e.g., a differential pair or a 2-bit wide bus) connected to two terminals. Bus 222 allows for storage controller 200 to read data from and write data to mass storage 202.

Storage module 120 also includes mass storage 202, which includes one or more memory blocks on one or more chips having memory circuits or cells for storing one or more bits of information. For example, mass storage 202 may be implemented with a non-volatile memory such as NAND flash memory having memory cells/circuits (e.g., NAND cells) each capable of storing one bit (single level cell) or multiple bits (multi-level cell) of data. Other forms of non-volatile memory may also be used without departing from embodiments of the present disclosure. Mass storage 202 may be physically and/or logically divided. For example, mass storage 202 may be implemented as a single chip. Alternatively, mass storage 202 may be implemented with several discrete chips that are connected together in a single package (as shown in FIG. 2) or, alternatively, separately packaged and externally connected together. Mass storage 202 may also be divided up into blocks, which are then further divided into pages. Storage controller 200 is connected to mass storage 202 through bus 222, which allows for storage controller 200 to read data from and write data to mass storage 202.

RAM 214 is present in some embodiments of the present disclosure; storage controller 200 may use RAM 214 to store operating information (e.g., operating code and/or state information) that may need to be readily/quickly accessed. For example, RAM 214 may store a translation table that describes how logical addresses are mapped to physical addresses of mass storage 202. When RAM 214 is not implemented, in case there is not enough RAM 214 within storage module 120, or in other cases, storage controller 200 may instead request and use a portion of system memory 108 of host 100 (see FIG. 1), as described in U.S. patent application Ser. No. 12/455,763, filed Jun. 4, 2009, now patented as U.S. Pat. No. 8,874,824 and assigned to the assignee of the present application, and which is incorporated herein by reference in its entirety.

Clock generation circuit 206 may be implemented with a circuit that is capable of generating a clock signal. For example, clock generation circuit 206 may be implemented using common clock recovery and/or generation circuits including PLLs, oscillators, voltage controlled oscillators, delay locked loops, frequency detectors, frequency multipliers/dividers, phase detectors, combinations of these circuits, or any other suitable circuit. Clock generation circuit 206 may also rely on other components, such as resistors, capacitors, inductors, crystals, or MEMS devices. Clock generation circuit 206 may also be programmable to provide a clocking signal output that varies according to the inputs that it receives. For example, clock generation circuit 206 may be configured to produce a clocking signal of a very high quality (e.g., low jitter) when a reference clock signal is present on reference clock line 218B. Clock generation circuit 206 may also be configured to produce a clocking signal of a lower quality when a reference clock signal is absent. As other examples, the frequency, duty cycle, jitter, output skew, or propagation delay of the outputted clocking signal may be set according to inputs (e.g., control bits) that are provided to clock generation circuit 206 through bus 205. In alternative architectures, clock generation circuit 206 may have direct access to registers 212 without going through control circuit 204 or clock generation circuit 206 or may have a register internal to itself for storing clock configuration information. While clock generation circuit 206 is shown to be part of storage controller 200, clock generation circuit 206 may also be implemented external to storage controller 200 without departing from embodiments of the present disclosure.

Receiver circuit 208 and transmitter circuit 210 receive the internal clock signal on internal clock line 207 so that storage module 120 may transfer data to host 100 at higher rates than without a clock signal. In another embodiment, internal clock line 207 only provides the internal clock signal to the receiver circuit 208, but not to the transmitter circuit 210. In yet another embodiment, internal clock line 207 only provides the internal clock signal to the transmitter circuit 210, but not to the receiver circuit 208.

Registers 212 store one or more bits of information regarding the operation of storage module 120, including information regarding the operation of clock generation circuit 206 or other features of storage module 120. Registers 212 may be implemented as part of storage controller 200, as part of mass storage 202, as part of RAM 214, or as part of some other memory circuit in storage module 120. The memory used for registers 212 may be any type. For example, registers 212 may be implemented in volatile memory (e.g., SRAM, DRAM), non-volatile memory (e.g., flash, magnetic, resistive), ROM, one time programmable memory, or any combination of different types of memory.

Registers 212 may include several individual registers, e.g., registers 212A-212H of similar or different sizes. For example, register 212A may be a 1-byte register while registers 212B-212E may be 1-bit registers and register 212F may be a 4-byte register. Registers 212 may be used to store several specific types of information. In one case, some of registers 212 store read-only information that describes how storage module 120 operates (e.g., supported features) or specifications for storage module 120 to properly operate or to operate at different levels of performance (e.g., current specifications for different transfer rates). In another case, some of registers 212 store writeable information that configures how storage module 120 operates or what storage module 120 needs to operate. In yet another case, some of registers 212 store information about how storage module 120 is currently operating or the current state of storage module 120. Together, registers 212 may also store some or all of the different types of information described above along with other types of data. Registers 212 may also be used to implement descriptors, flags, and attributes as described in JEDEC Standard No. 220A for Universal Flash Storage (UFS 1.1), published June 2012, which is incorporated by reference herein in its entirety.

In one case, registers 212 store information that describes a region of mass storage 202 that is write protected (either permanently or temporarily). For example, register 212F may define an address range, a block range, a partition, or the like that defines the region. Another register, e.g. register 212G, may define whether the region is permanently, temporarily, or authenticated write protected. In the case of permanent or temporary, the region is protected as described in U.S. application Ser. No. 11/176,669, filed Jul. 8, 2005, now patented as U.S. Pat. No. 7,827,370, which is assigned to the assignee of the present application, and which is hereby incorporated by reference in its entirety. However, in the case of the region being authenticated write protected, the region may be written/programmed to if authentication of the data to be written is successful.

Control circuit 204 may include a state machine or several state machines. Alternatively, as another example, control circuit 204 may include a general purpose processor or microcontroller that is programmed to control storage module 120. For example, a processor programmed with firmware may implement one or more state machines that govern the operation of storage module 120. Firmware or other software for programming control circuit 204 may be stored in dedicated storage or in a reserved storage area on mass storage 202. As another alternative, control circuit 204 may be implemented as a combination of a general purpose processor programmed with firmware or the like and special purpose circuitry that performs specific functions.

Among the aspects of storage module 120 that control circuit 204 controls is the operation of clock generation circuit 206. In particular, using information stored in registers 212 and state information, which, in some examples, may also be stored in registers 212 or alternatively in RAM 214, control circuit 204 supplies control information (e.g., control bits) to clock generation circuit to control the operation of the internal clock signal.

Other functions of control circuit 204 include receiving command signals from host 100 to perform certain functions. For example, control circuit 204 may receive command signals from host 100 to read information from or write information to registers 212. For instance, control circuit 204 may receive a command to read registers 212 in a location that stores a state of storage module 120 (e.g., a power state, a programming state, etc.).

It should be understood that the architecture of FIG. 2 is an example for ease of discussion only and should not be considered limiting. Circuits, buses, lines, modules and the like may have been simplified, left out, or otherwise combined with other components in FIG. 2. For example, storage module 120 is shown to have buses, including internal clock line 207, bus 205, bus 213, bus 211, and bus 222; these buses may be removed, combined, rerouted, and/or added to without departing from embodiments of the present disclosure. As another example, the functionality of control circuit 204 may be greatly expanded over what is described above or the functions described above by control circuit 204 may be spread across different circuits.

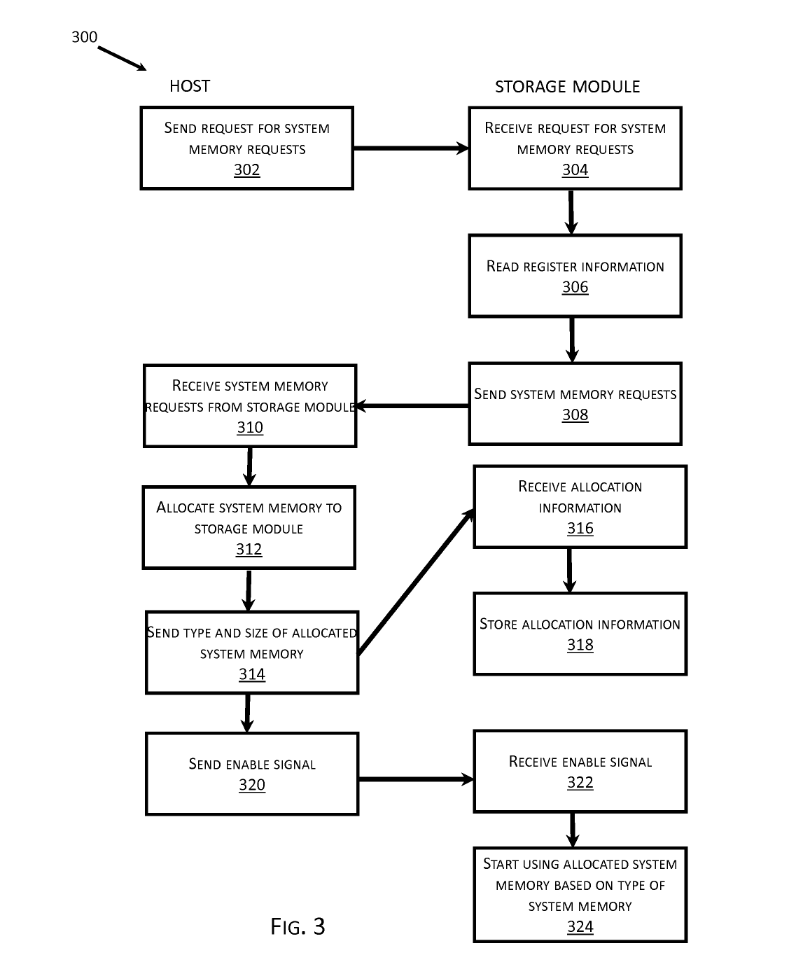

FIG. 3 depicts an exemplary process flow for a first embodiment. In step 302, host 100 first may check the requested type(s) and amount(s) of system memory 108 from the descriptors of the storage module 120 (e.g., in one or more registers of registers 212). In step 304, storage module 120 receives the request from the host 100. The form of the request may be, for example, a read command to a specific register storing the system memory request information or a specialized command. In step 306, storage module 120 reads register information that indicates the types and amounts of system memory that storage module 120 requests. For example, in a system where host 100 has volatile and non-volatile portions in system memory 108 (FIG. 1), storage module 120 may have two descriptors (e.g., register 212G and register 212H) that store system memory request information: one descriptor provides the requested amount of volatile system memory and another descriptor provides the requested amount of non-volatile system memory. In some embodiments, the storage module 120 also has one or more registers that indicate whether the storage module 120 supports various types of system memory (e.g., volatile and non-volatile). In step 308, storage module 120 sends the system memory request information back to host 100 either in response to the request of step 302 or in response to some other command (not shown).

In step 310, host 100 receives the system memory request information. In step 312, after checking the requested types and amounts of system memory, host 100 may allocate portions of system memory 108 to storage module 120 based on the requested system memory received in step 310. The amount allocated may be a specified amount, less than the specified amount, or more than the specified amount. For example, in a case where storage module 120 requested 10 kB of volatile memory and 5 kB of non-volatile memory, in one instance host 100 may allocate 10 kB of volatile system memory and 5 kB of non-volatile system memory. In another instance, host 100 may allocate 0 kB of volatile system memory and 8 kB of non-volatile system memory. In other instances, host 100 may allocate other combinations of volatile and non-volatile system memory.

In step 314, after allocation, host 100 sends information about the allocation (e.g., the amount of each type of supported system memory and the type of the memory) to storage module 120. (Step 314: “Send type and size of allocated system memory.”) For example, host 100 may perform a write command to an attribute register (e.g., a register of registers 212). In step 316, storage module 120 receives the allocation information, and in step 318, the storage module stores the allocation information in the appropriate attribute register, e.g., the attribute register that is appropriate with respect to the type of memory indicated by the allocation information. Thus, in at least one embodiment, each attribute register corresponds to a particular memory type.

In step 320, host 100 enables storage module 120 to utilize the allocated system memory by, for example, sending an enable signal with a write command that programs a bit to a flag (e.g., register 212B) in storage module 120.

In step 322, storage module 120 receives the enable signal and may configure itself to use the unified memory (which may also be called extended memory). In some cases the unified memory will include RAM 214 combined with the system memory that was allocated to storage module 120 in steps 312, 314, 316, and 318. However, in other cases the unified memory may only include the allocated system memory. For example, in storage modules that do not include RAM 214, the unified memory would be entirely made up of the allocated system memory.

In step 324, after the system memory allocated to storage module 120 is enabled, the allocated system memory may be used based on the type of memory that was allocated. For example, storage module 120 may determine where to store information based on the importance of the data (e.g., more important data may go to non-volatile system memory), may determine where to store information in low power states based on the system memory that stays powered on or specifies the lowest amount of power, or may determine where to store information based on which type of memory has the best heat tolerance. Storage module 120 may use other factors as well when determining how to utilize the different types of system memory differently.

In a second embodiment, the allocation of different memory types for utilization by storage module 120 may take place by a request message from storage module 120 (e.g. a separate UFS UM access command). For example, different commands (index) or command arguments may be used to generate a request for run-time allocation of different memory types or utilization of already allocated pieces of system memory both when writing (e.g., flags of a Write UM Buffer command) new data from the storage module to the allocated piece of system memory or while copying data (either inside the allocated piece of system memory or to/from other parts of the system memory from/to the allocated part of the system memory).

In a third embodiment, a combination of the techniques from the first embodiment and the second embodiment is used where the host initially reads a register of the storage module to determine storage modules specifications regarding system memory. After reading the register, the host and storage module may communicate using messages similar to those described in the second embodiment to negotiate an appropriate allocation(s), type(s), or other properties of system memory for the storage module to use.

Embodiments of the present disclosure include a storage module comprising memory blocks having a plurality of memory circuits for storing data. An interface is configured to connect the storage module to a host having system memory. A first register is configured to provide data that indicates whether a first type of system memory is supported by the storage module when the storage module uses a unified memory, wherein the unified memory includes some system memory. A second register is configured to provide data that indicates whether a second type of system memory is supported by the storage module when using the unified memory. A third register is configured to receive data that indicates the amount of system memory of the first type included in the unified memory. And a controller is configured to use the unified memory in accordance with the amount indicated in the third register.

Embodiments of the present disclosure include a storage module, comprising means for storing data, such as for example mass storage 202. The storage module comprises means for connecting the storage module to a host having system memory, such as for example data out line 215B and data terminal 215A, data in line 216B and data terminal 216A, includes reference clock line 218B and reference clock terminal 218A, and power line 220B and power terminal 220A. The storage module further comprises means for providing information about a type of system memory to be allocated to the storage module, such as for example one or more of registers 212. The storage module further comprises means for utilizing the system memory based at least in part upon the information about the type of system memory, such as for example the storage controller 200 and the control circuit 204.

In some embodiments, the means for providing information about the type of system memory to be allocated to the storage device corresponds to the type of system memory to be allocated to the storage device, and the information provided by the means for providing information about a type of system memory to be allocated to the storage device relates to an amount of the type of system memory to be allocated to the storage device. In some embodiments, the storage device further comprises means for providing other information about another type of system memory that is allocated to the storage device, such as for example one or more of registers 212, wherein the means for utilizing the system memory is further based on the other information about the other type of system memory.

What is claimed is:

1. A storage device comprising:
memory blocks having a plurality of memory circuits for storing data;
an interface to connect the storage device to a host having system memory; and
at least one register for providing information about a type of system memory to be allocated to the storage device,
wherein the storage device is configured to utilize the system memory based at least in part upon the information about the type of system memory.

2. The storage device of claim 1, wherein the at least one register corresponds to the type of system memory to be allocated to the storage device, and the information provided by the at least one register relates to an amount of the type of system memory to be allocated to the storage device.

3. The storage device of claim 1, wherein the storage device is further configured to utilize the system memory by writing to the system memory.

4. The storage device of claim 1, wherein the information about the type of system memory comprises bits identifying the type of system memory.

5. The storage device of claim 1, wherein the type of system memory is at least one of volatile memory or non-volatile memory.

6. The storage device of claim 1, wherein the type of system memory relates to at least one of a degree of heat tolerance or a level of power consumption.

7. The storage device of claim 1, wherein the storage device is further configured to store the data in the type of system memory based on an importance of the data.

8. The storage device of claim 1, comprising:
another register for providing other information about another type of system memory to be allocated to the storage device;
wherein the storage device is further configured to utilize the system memory at least based on the information about the type of system memory and the other information about the other type of system memory.

9. The storage device of claim 1, further comprising:
random access memory (RAM) configured to store operating information.

10. The storage device of claim 9, wherein the type of system memory to be allocated to the storage device, along with the RAM, is at least part of a unified memory.

11. The storage device of claim 9, wherein the type of system memory to be allocated to the storage device is at least part of a unified memory.

12. The storage device of claim 9, wherein the RAM is at least one of magnetoresistive RAM (MRAM), ferroelectric RAM (FE-RAM), or resistive RAM.

13. The storage device of claim 1, further comprising a random access memory (RAM) that is configured to store operating information, wherein the RAM is included in a unified memory, the type of system memory to be allocated to the storage device, along with the RAM, is at least part of the unified memory, the type of system memory is a first type of system memory, and the storage device further comprising:
another register configured to receive other information that indicates an amount of system memory of a second type of system memory included in the unified memory;
wherein the unified memory includes a first portion of the system memory of the first type and a second portion of the system memory of the second type;
wherein the storage device is further configured to utilize a first portion of the unified memory for a different purpose than that for a second portion of the unified memory, wherein the first portion of the unified memory includes the first portion of the system memory and the second portion of the unified memory includes the second portion of the system memory.

14. The storage device of claim 1, wherein the at least one register is an attribute-register of Universal Flash Storage (UFS) standard.

15. A storage device comprising:
a plurality of memory circuits for storing data;
an interface to connect the storage device to a host having system memory; and
a storage controller having at least one register for providing information about a type of system memory to be allocated to the storage device,
wherein the storage controller is configured to utilize the system memory based at least in part upon the information about the type of system memory.

16. The storage device of claim 15, wherein the at least one register corresponds to the type of system memory to be allocated to the storage device, and the information provided by the at least one register relates to an amount of the type of system memory to be allocated to the storage device.

17. The storage device of claim 15, wherein the storage controller is further configured to utilize the system memory by writing to the system memory.

18. The storage device of claim 15, wherein the information about the type of system memory comprises bits identifying the type of system memory.

19. The storage device of claim 15, wherein the type of system memory is at least one of volatile memory or non-volatile memory.

20. The storage device of claim 15, wherein the type of system memory relates to one or more of a degree of heat tolerance or a level of power consumption.

21. The storage device of claim 15, wherein the storage controller is further configured to store the data in the type of system memory based on an importance of the data.

22. The storage device of claim 15, comprising:
another register for providing other information about another type of system memory to be allocated to the storage device;
wherein the storage controller is further configured to utilize the system memory based at least on the information about the type of system memory and the other information about the other type of system memory.

23. The storage device of claim 15, further comprising:
random access memory (RAM) configured to store operating information.

24. The storage device of claim 23, wherein the type of system memory to be allocated to the system memory along with the RAM is at least part of a unified memory.

25. The storage device of claim 23, wherein the type of system memory to be allocated to the system memory is at least part of a unified memory.

26. The storage device of claim 23, wherein the RAM is at least one of magnetoresistive RAM (MRAM), ferroelectric RAM (FE-RAM), or resistive RAM.

27. The storage device of claim 15, further comprising a random access memory (RAM) that is configured to store operating information, wherein the RAM is included in a unified memory, the type of system memory to be allocated to the storage device, along with the RAM, is at least part of the unified memory, the type of system memory is a first type of system memory, and the storage controller further comprising:
another register configured to receive other information that indicates an amount of system memory of a second type of system memory included in the unified memory;
wherein the unified memory includes a first portion of the system memory of the first type and a second portion of the system memory of the second type;
wherein the storage controller is further configured to utilize a first portion of the unified memory for a different purpose than that for the second portion of the unified memory, wherein the first portion of the unified memory includes the first portion of the system memory and the second portion of the unified memory includes the second portion of the system memory.

28. The storage device of claim 15, wherein the at least one register is an attribute-register of Universal Flash Storage (UFS) standard.

29. A method comprising:
storing, by a storage device, data in a plurality of memory circuits;
providing, by at least one register of the storage device to a host having system memory, information about a type of system memory to be allocated to the storage device; and
utilizing, by the storage device, the system memory based at least in part upon the information about the type of system memory.

30. The method of claim 29, wherein the at least one register corresponds to the type of system memory to be allocated to the storage device, and the information provided by the at least one register relates to an amount of the type of system memory to be allocated to the storage device.

31. The method of claim 29, wherein the utilizing comprises writing some or all of the data to the system memory.

32. The method of claim 29, wherein at least one of:
the type of system memory is at least one of volatile memory or non-volatile memory;
the type of system memory relates to a degree of heat tolerance; or
the type of system memory relates to a level of power consumption.

33. The method of claim 29, wherein another register contains other information about another type of system memory that is allocated to the storage device, the method further comprising:
utilizing the system memory based at least in part on the information about the type of system memory and the other information about the other type of system memory.

34. A host system, comprising:
system memory;
an interface for interfacing the host system with a storage device that comprises a plurality of memory circuits for storing data; and
a host controller configured to:
receive, from the storage device, a system memory allocation request including at least a type of system memory; and
allocate, based on the system memory allocation request, an amount of the type of system memory to the storage device.

35. The host system of claim 34, wherein the storage device includes at least one register for providing information about the type of system memory to be allocated to the storage device.

36. The host system of claim 35, wherein the host controller is configured to receive the system memory allocation request by reading the system memory allocation request from the at least one register of the storage device.

37. The host system of claim 36, wherein the at least one register of the storage device is associated with the type of system memory requested in the system memory allocation request.

38. The host system of claim 36, wherein the at least one register of the storage device stores at least the type of system memory requested in the system memory allocation request.

39. The host system of claim 34, wherein the host controller is configured to transmit the information indicating at least the type of system memory allocated to the storage device by writing the amount of the type of system memory allocated to the storage device to a register of the storage device.

40. The host system of claim 39, wherein the register of the storage device is associated with the type of system memory allocated to the storage device.

41. The host system of claim 39, wherein the register of the storage device stores at least the type of system memory allocated to the storage device.

42. A storage device, comprising:
means for storing data;
means for connecting the storage device to a host having system memory;
means for providing information about a type of system memory to be allocated to the storage device; and
means for utilizing the system memory based at least in part upon the information about the type of system memory.

43. The storage device of claim 42, wherein the means for providing information about the type of system memory to be allocated to the storage device corresponds to the type of system memory to be allocated to the storage device, and the information provided by the means for providing information about a type of system memory to be allocated to the storage device relates to an amount of the type of system memory to be allocated to the storage device.

44. The storage device of claim 42, further comprising:
means for providing other information about another type of system memory that is allocated to the storage device;
wherein the means for utilizing the system memory is further based on the other information about the other type of system memory.
